(19) United States
(12) Patent Application Publication
(10) Pub. No.: US 2007/0097506 A1
(43) Pub. Date: May 3, 2007

(54) IMAGE STABILIZING OPTICAL SYSTEM

(75) Inventor: Fu-Ming Chuang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: YOUNG OPTICS INC., Hsinchu (TW)

(21) Appl. No.: 11/535,494

(22) Filed: Sep. 27, 2006

(30) Foreign Application Priority Data
Nov. 3, 2005 (TW) 94138536

(51) Int. Cl. G02B 27/64

(52) U.S. Cl. 359/554; 359/831

(57) ABSTRACT

An optical system with an optical axis is provided. The optical system includes at least a lens group and a light deflection element. The lens group includes a plurality of lenses lined along the optical axis. The light deflection element is disposed along the optical axis and located inside or outside the lens group. The light deflection element comprises two substrates and a liquid crystal layer between the substrates. Two electrode layers are respectively disposed on surfaces of the substrates that contact the liquid crystal layer. An electric field is applied to the liquid crystal layer through the electrode layers to vary the refractive index of the liquid crystal layer. An included angle exists between the substrates.

### CROSS-REFERENCE TO RELATED APPLICATION

This application claims the priority benefit of Taiwan application serial no. 94138536, filed on Nov. 3, 2005. All disclosure of the Taiwan application is incorporated herein by reference.

### BACKGROUND OF THE INVENTION

1. Field of the Invention

The present invention relates to an optical system. More particularly, the present invention relates to an optical system with image stabilizing capability.

2. Description of the Related Art

With continuous improvement of image-sensing devices, micro-storage medium, and the reduced production cost, a digital camera market continues to expand, leading to a greater demand for more expensive single lens cameras. However, a user did not hold the camera steady when taking a picture, the image captured by the camera will be fuzzy due to the shake. In particular, when a high magnification telescopic lens is used for capturing an image, minor vibration can cause significant fuzziness in the final picture. Hence, a means of minimizing the shaking of cameras for producing a clearer image is always a major research topic for camera manufacturers.

As shown in FIG. 1A, there is no shaking in a period that the camera shutter is opened, then the light from a target point A10 is steadily focused on an image point M10 on an image-sensing device 30. However, there is some shaking in the period that the camera shutter is opened, the focus point of the light from the target point A10 shifts from the image point M10 to another image point M12 as shown in FIG. 1B. In the way, the image obtained by the image-sensing device (or a film negative) 30 is fuzzy. To minimize the fuzziness in the image due to shakes, one conventional method is to provide a mechanism for moving the lens 20 as soon as the camera shakes as shown in FIG. 1C. Thus, the light from the target point A10 remains to be focused on the image point M10 of the image-sensing device 30. In another conventional method, the image-sensing device 30 is moved instead to compensate for the shaking.

All in all, regardless of the technique used for counteracting the shakes, sophisticated mechanism needs to be installed on either the image-sensing device or the lens so that a real-time correction for any motion in the camera can be effected. These sophisticated mechanism not only is expensive, slow to respond and difficult to assemble, but also produces considerable noise due to mechanical friction, reducing its overall reliability. Moreover, if the correcting mechanism is driven by electric power, the power consumption of the camera increases, which is shorten the working time of the battery.

### SUMMARY OF THE INVENTION

Accordingly, at least one objective of the present invention is to provide an image stabilizing optical system suitable for reducing fuzzy image due to system shakes.

To achieve these and other advantages and in accordance with the purpose of the invention, as embodied and broadly described herein, the invention provides an image stabilizing optical system with an optical axis. The optical system includes at least a first lens group and a light deflection element. The first lens group includes a plurality of lenses lined along the optical axis. The light deflection element is disposed along the optical axis and located inside or outside the first lens group. The light deflection element comprises two substrates and a liquid crystal layer between the substrates. Furthermore, two electrode layers are respectively disposed on surfaces of the substrates that contact the liquid crystal layer. An electric field applied to the liquid crystal layer to vary the refractive index of the liquid crystal layer is controlled by the electrode layers. An included angle exists between the substrates.

The image stabilizing optical system further includes a second lens group disposed along the optical axis on one side of the first lens group. The second lens group is suitable for moving along the optical axis to zoom in or zoom out.

The image stabilizing optical system further includes an image-sensing device disposed along the optical axis and on the image-forming surface of the first lens group. The light deflection element is used for stabilizing the image on the image-sensing device. The light deflection element could be disposed between the first lens group and the image-sensing device. The image-sensing device is a complementary metal-oxide-semiconductor (CMOS) or a charge coupled device (CCD).

The image stabilizing optical system further includes a controller electrically connected to the light deflection element for controlling the electric field strength applied to the liquid crystal layer. The controller includes a displacement-sensing module and a microprocessor, for example. The displacement-sensing module is used for detecting displacement of the optical system. The microprocessor is electrically connected to the displacement-sensing module and the light deflection element for changing the electric field strength applied to the liquid crystal layer according to a detection result obtained by the displacement-sensing module. The displacement-sensing module comprises a horizontal displacement sensor and a vertical displacement sensor.

The first lens group in the image stabilizing optical system is also adapted to moving along the optical axis for zooming in or zooming out. The liquid crystal layer is a nematic liquid crystal layer, for example. The electrode layers are made of a material such as indium tin oxide (ITO) or indium zinc oxide (IZO), for example.

In brief, the image stabilizing optical system in the present invention utilizes an electric field applied to the liquid crystal layer of the light deflection element to change the refractive index and produce the light deflection effect. Therefore, without any moving element, the present invention compensates for the shifted image resulted from a shaky optical system so that fuzzy images are prevented.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A through 1C are schematic diagrams showing a stabilizing mechanism inside a conventional camera.

FIG. 2 is a diagram showing the image stabilizing optical system according to a first embodiment of the present invention.

FIG. 3 is a diagram showing the light deflection element in the image stabilizing optical system according to a third embodiment of the present invention.

FIGS. 4˜6 are diagrams showing the image stabilizing optical systems according to another three kinds of embodiments of the present invention.

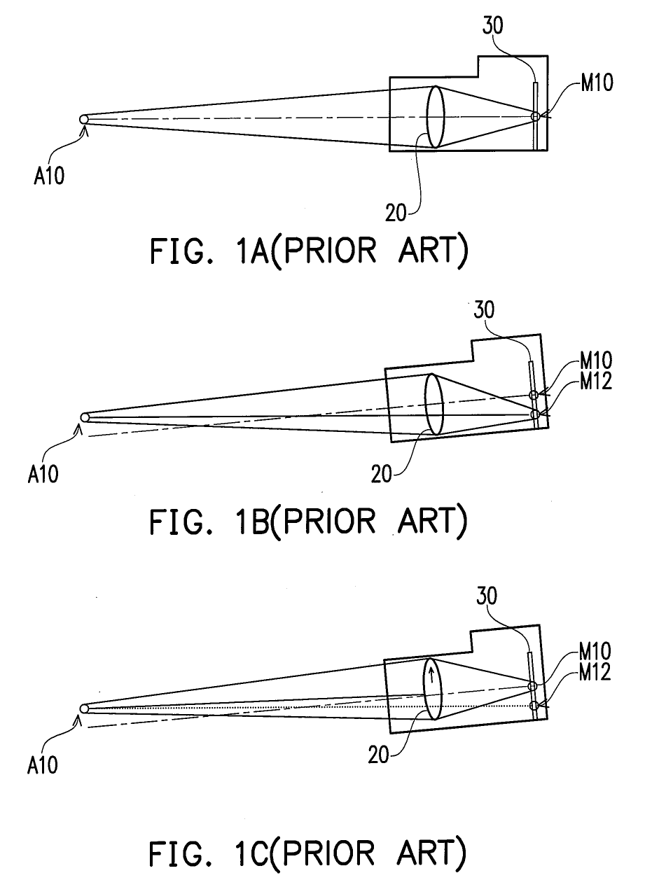

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The image stabilizing image system in the present invention comprises at least a lens group and a light deflection element. The lens group includes at least one lens and the lens and the light reflection element are lined along an optical axis. To simplify the description, four lens groups are used in the embodiment.

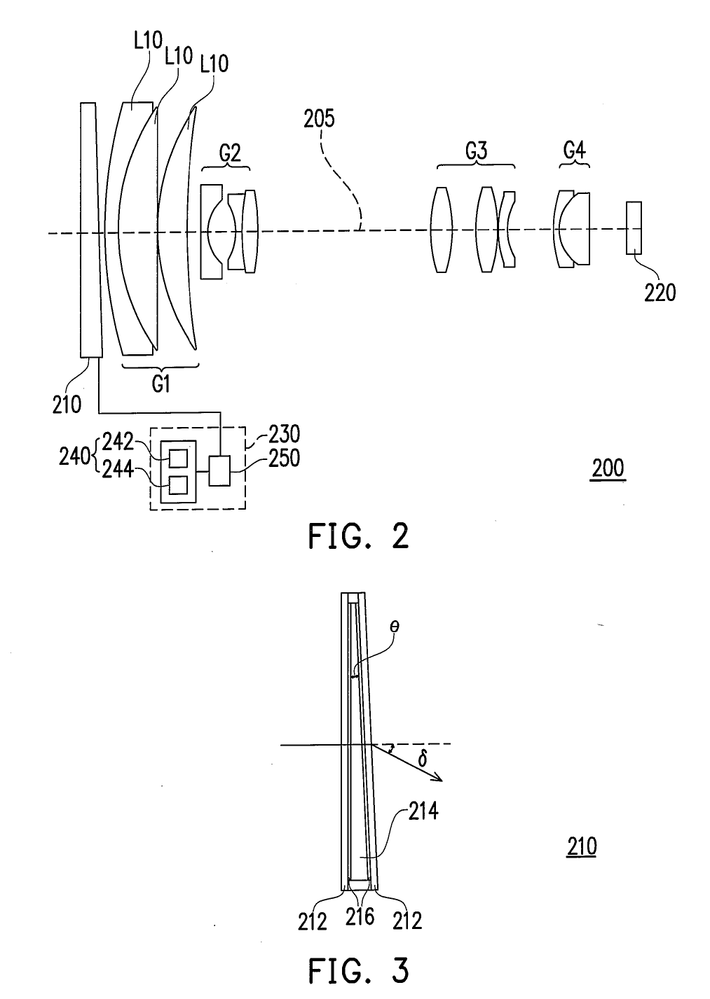

As shown in FIG. 2, the image stabilizing optical system 200 in the present invention has an optical axis 205. The image stabilizing optical system 200 includes a first lens group G1 and a light deflection element 210. The first lens group G1 has a plurality of lenses L10 disposed on and lined along the optical axis 205. The light deflection element 210 is also disposed along the optical axis 205 and located inside the first lens group G1 or outside the first lens group G1. In the present embodiment, the light deflection element 210 is located outside the first lens group G1. However, the light deflection element 210 is also disposed between any two lenses L10 or between the lenses of other lens group or between lens groups themselves. In general, there is no specific limitation on the position of the light deflection element 210.

As shown in FIG. 3, the light deflection element 210 comprises a pair of substrates 212 and a liquid crystal layer 214 disposed between the substrates 212. Two electrode layers 216 are respectively disposed on surfaces of the substrates 212 that contact the liquid crystal layer 214. An electric field is applied to the liquid crystal layer 214 through the electrode layers 216 so that the liquid crystal molecules inside the liquid crystal layer 214 change their alignment direction according to the strength of the electric field. Because the liquid crystal molecules have a single axis with double refraction property (that is, having mutually perpendicular fast axis and slow axis in a single axle direction), the refractive index of the liquid crystal layer will vary when the liquid crystal molecules change direction controlled by the electric field. Furthermore, an included angle 0 exists between the substrates 212. In other words, the two substrates 212 are not parallel to each other, but rather form a wedge-shaped panel. The electrode layers 216 are made of indium tin oxide (ITO), indium zinc oxide (IZO) or some other transparent conductive materials, for example. The liquid crystal layer 214 is a nematic liquid crystal layer or a liquid crystal layer in other types, for example. The substrate 212 is a glass substrate or other transparent substrate, for example.

As shown in FIGS. 2 and 3, the refractive index of the light deflection element 210 is different from the refractive index of the external medium (for example, air). Furthermore, the light deflection element 210 has a wedge shape so that light passing through the light deflection element 210 is deflected. The relation of the included angle θ between the two substrate 212, the refractive index n, of the liquid crystal layer 214, the refractive index n₂ of the external medium and the deflection angle δ after penetrating through the light deflection element 210 is given by: δ=(n₁−n₂)θ. In the present embodiment, the external medium (air) has a refractive index 1, so that δ=(n₁−1)θ. Based on this relation, changing the electric field strength applied to the liquid crystal layer 214 varies the refractive index n, of the liquid crystal layer 214 when the image stabilizing optical system 200 shakes. Hence, the light is deflected to prevent a shifted image from causing a fuzzy image.

Since the image stabilizing optical system 200 prevents any shifting in the image through controlling the electric field strength applied to the light deflection element 210 alone, there is no need to move the first lens group G1 or the image-sensing device 220 (described hereafter) as in the conventional technique. In other words, the image stabilizing optical system 200 in the present invention not only eliminates the cost of producing complicated driving mechanism and minimizes the difficulties in assembling them, but also avoids the noise resulting from mechanical friction and lower reliability due to the mechanical elements. Moreover, considerable energy for driving the mechanism is saved. In addition, the light deflection element 210 provides a faster response and operates with better reliability than the moving mechanism used in the conventional technique.

In the present invention, the number of light deflection elements 210 used inside the optical system 200 is not limited. In general, the number of light deflection elements 210 depends on the actual requirements. In addition, the image stabilizing optical system 200 further includes a second lens group G2 or even a third lens group G3 and/or a fourth lens group G4 disposed on the optical axis 205. The number of lens groups changes according to the actual design. Furthermore, at least two of the lens groups G1˜G4 are adapted to moving along the optical axis 205 for zooming in or zooming out purpose such as magnification or reduction.

The image stabilizing optical system 200 further includes an image-sensing device 220 disposed on the optical axis 205 and located in an image-forming surface after the light passed through all the lens groups. The image-sensing device 220 is used for detecting the light that passed through the lens groups G1˜G4 and arrived at the light deflection element 210 and converting the light into image signals. Meanwhile, through the light deflection element 210, the image falling on the image-sensing device 220 is stabilized. The image-sensing device 220 is a complementary metal-oxide-semiconductor (CMOS), a charge-coupled device (CCD) or other types of image-sensing device.

In addition, the image stabilizing optical system 200 further includes a controller 230 electrically connected to the light deflection device 210 for controlling the electric field strength applied to the liquid crystal layer 214. More specifically, the controller 230 comprises a displacement-sensing module 240 and a microprocessor 250. The displacement-sensing module 240 is a device for sensing any displacement of the image stabilizing optical system 200 and the microprocessor 250 controls the electric field strength applied to the liquid crystal layer 214 according to the detection result obtained by the displacement-sensing module 240. Moreover, the displacement-sensing module 240 comprises a horizontal displacement sensor 242 and a vertical displacement sensor 244 so that the amount of horizontal and vertical displacement in the image stabilizing optical system 200 is measured separately.

In the aforementioned embodiment, the light deflection element 210 is located outside the first lens group G1. However, the light deflection element 210 could be disposed between the first lens group G1 and the image-sensing device 220 and other positions as illustrated in the following embodiments.

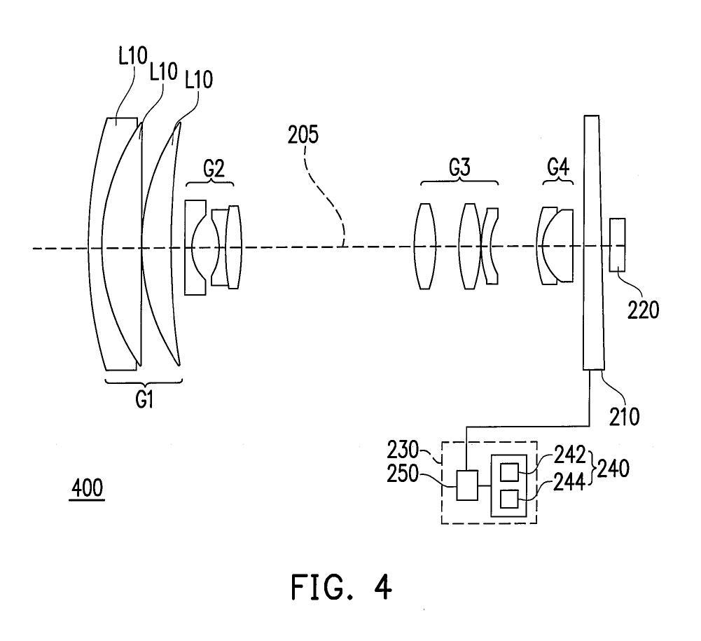

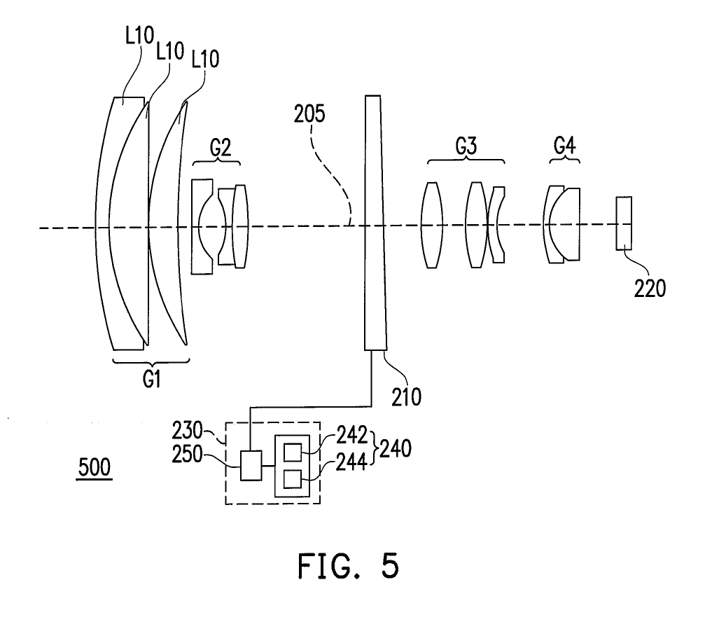

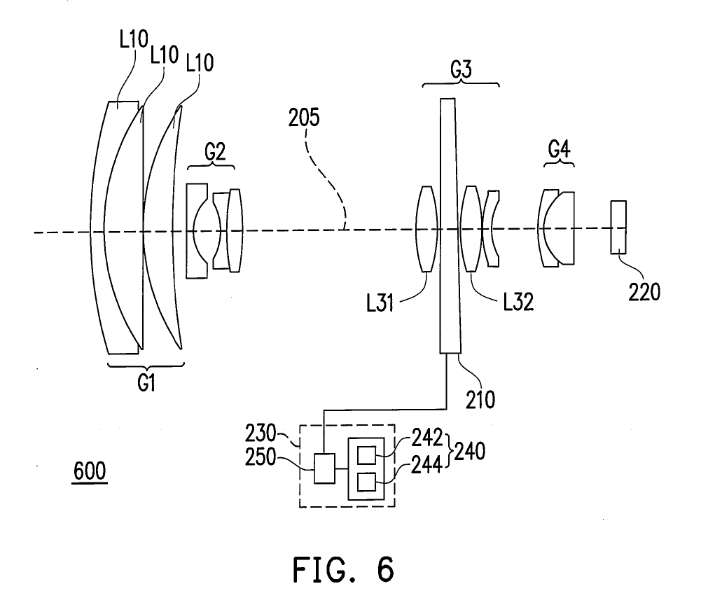

As shown in FIG. 4, the light deflection element 210 in the image stabilizing optical system 400 of the present embodiment is disposed between the fourth lens group G4 and the image-sensing device 220. Because the fourth lens group G4 and the image-sensing device 220 are separated from each other by a distance, the insertion of F the light deflection element 210 between them is not necessary to increase the overall length of the image stabilizing optical system 400. Thus, the demand for an optical system with a simpler configuration is met.

As shown in FIG. 5, the light deflection element 210 in the image stabilizing optical system 500 of the present embodiment is disposed between the second lens group G2 and the third lens group G3. In practice, the light deflection element 210 is also disposed between the first lens group G1 and the second lens group G2 or between the third lens group G3 and the fourth lens group G4. Obviously, if additional lens groups are installed in the image stabilizing optical system 500, the light deflection element 210 is disposed between any two of the lens groups according to the design.

As shown in FIG. 6, the light deflection element 210 in the image stabilizing optical system 600 of the present embodiment is disposed between the lens L31 and the lens L32 of the third lens group G3. Similarly, because there is already a gap separating the lens L31 from the lens L32 inside the third lens group G3, the insertion of the light deflection element 210 between them is not necessary to increase the overall length of the image stabilizing optical system 600. Hence, the demand for an optical system with a simpler configuration is met. In addition, the sensitivity to any shifting is higher within the third lens group G3 (for example, between the lens L31 and the second lens L32). Therefore, image shifting can be corrected much faster when the light deflection element 210 is disposed in this position. As a result, the image stabilizing optical system 600 has higher shaking compensation sensitivity. Obviously, the light deflection element 210 is disposed anywhere within the lens groups.

In summary, the image stabilizing optical system in the present invention utilizes an electric field applied to the liquid crystal layer of the light deflection element to change the refractive index and deflect the light when the optical system shakes.: Hence, the image-sensing device is prevented from receiving a shifted and fuzzy image. Because the present invention requires no moving parts to compensate for the shifted image resulting from shakes the cost for producing the components of a complicated mechanism and the time for assembling the components together are entirely eliminated. Moreover, without any moving mechanical components, less noise is produced and the optical system has better reliability. Meanwhile, the light deflection element also consumes less power and has a quicker response to motion.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image stabilizing optical system defining an optical axis, comprising:
a first lens group having a plurality of lenses, the lenses disposed on and lined along the optical axis; and
a light deflection element, disposed on the optical axis and located inside the first lens group or outside the first lens group, wherein the light deflection element includes a pair of substrates and a liquid crystal layer disposed between the two substrates, and two electrode layers are respectively disposed on surfaces of the substrates that contact the liquid crystal layer, an electric field is applied to the liquid crystal layer through the electrode layers to change the refractive index of the liquid crystal layer, and an included angle exists between the substrates.

2. The image stabilizing optical system of claim 1, further including a second lens group disposed on the optical axis adjacent to the first lens group.

3. The image stabilizing optical system of claim 2, wherein the second lens group is adapted to move along the optical axis to zoom in or zoom out.

4. The image stabilizing optical system of claim 1, wherein the first lens group is adapted to move along the optical axis to zoom in or zoom out.

5. The image stabilizing optical system of claim 1, further including an image-sensing device disposed on the optical axis at the image-forming surface of the first lens group, and the light deflection element stabilizing the image detected by the image-sensing device.

6. The image stabilizing optical system of claim 5, wherein the light deflection element is disposed between the first lens group and the image-sensing device.

7. The image stabilizing optical system of claim 5, wherein the image-sensing device comprises a complementary metal-oxide-semiconductor (CMOS) transistor or a charge-coupled device (CCD).

8. The image stabilizing optical system of claim 1, further including a controller electrically connected to the light deflection element for controlling the electric field strength applied to the liquid crystal layer.

9. The image stabilizing optical system of claim 8, wherein the controller further includes:
a displacement-sensing module for detecting displacement of the optical system; and
a microprocessor electrically connected to the displacement-sensing module and the light deflection element for controlling the electric field strength applied to the liquid crystal layer according to a detection result obtained by the displacement-sensing module.

10. The image stabilizing optical system of claim 9, wherein the displacement-sensing module comprises a horizontal displacement sensor and a vertical displacement sensor.

11. The image stabilizing optical system of claim 1, wherein the liquid crystal layer includes a nematic liquid crystal layer.

12. The image stabilizing optical system of claim 1, wherein the electrode layers are made of indium tin oxide (ITO) or indium zinc oxide (IZO).
